(19) United States
(12) Patent Application Publication
(10) Pub. No.: US 2002/0104719 A1
(43) Pub. Date: Aug. 8, 2002

(54) Apparatus for mounting a disk brake

(76) Inventors: Shinichi Nakayama, Yamanashi (JP); Hideaki Ishii, Yamanashi (JP); Shinji Suzuki, Yamanashi (JP); Junichi Hashimoto, Yamanashi (JP)

Correspondence Address: WENDEROTH, LIND & PONACK, L.L.P., 2033 K STREET N. W., SUITE 800, WASHINGTON, DC, 20006-1021, US

(21) Appl. No.: 09/989,523

(22) Filed: Nov. 21, 2001

(30) Foreign Application Priority Data
Nov. 22, 2000 (JP) 356242/2000

(51) Int. Cl. F16D 65/14

(52) U.S. Cl. 188/73.46

(57) ABSTRACT

In a disk brake mounting apparatus wherein a knuckle 1 is provided with two disk brake mounting portions 2 and 3, and a disk brake 7 is fastened to the knuckle 1 with mounting bolts 5 and 6 passed through bolt-receiving holes provided in the mounting portions 2 and 3, respectively, the knuckle 1 is provided with a reinforcing connecting portion 15 formed by extending a body portion 10 of the knuckle 1. The reinforcing connecting portion 15 has its edge E1 extended radially outward in the radial direction of a rotor R with respect to a line L connecting the bolt-receiving holes of the two mounting portions 2 and 3. Thus, the torsional rigidity of the two mounting portions 2 and 3 is increased by the reinforcing connecting portion 15 to suppress vibrations in the opposite-phase mode in the rotor axial direction, thereby reducing low-frequency brake noise.

### BACKGROUND OF THE INVENTION

The present invention relates to a disk brake mounting apparatus for mounting a disk brake on a vehicle.

Conventionally, this type of disk brake mounting apparatus has a structure as shown in FIGS. 11 and 12. A knuckle 1 constituting a part of a suspension of a vehicle is provided with two disk brake mounting portions 2 and 3. A disk brake 7 is fastened to the knuckle 1 with mounting bolts 5 and 6 passed through bolt-receiving holes 4 (only one of them is illustrated), which are formed in the mounting portions 2 and 3, respectively. The disk brake 7 is herein a fixed caliper type disk brake, in which a caliper 8 containing opposed pistons is fastened to the knuckle 1. In the case of a floating caliper type disk brake, however, a carrier is fastened to the knuckle 1.

The knuckle 1 has a body portion 10 with a hub-fitting hole 9. The disk brake mounting portions 2 and 3 are provided on the periphery of the body portion 10, together with a strut mounting portion 11, a ball stud mounting portion 12, a stabilizer mounting portion 13, and so forth. In general, the disk brake mounting portions 2 and 3 are set at the respective distal ends of projecting portions (root portions) 14 projecting radially outward from the body portion 10 in the radial direction of the hub-fitting hole 9. Consequently, an edge E0 located between the disk brake mounting portions 2 and 3 has a concave configuration with vertexes defined by the two mounting portions 2 and 3.

Incidentally, the disk brake 7 generates braking force by pressing a pair of brake pads, which are provided on the inner and outer sides of the vehicle, against a rotor R rotating together with a hub (not shown) rotatably fitted through the shaft hole 9 of the knuckle 1. When the braking action takes place, the opposite ends of the caliper or the carrier oscillate in opposite directions in the rotor axial direction. That is, vibrations occur in the opposite-phase mode in the rotor axial direction. This causes low-frequency brake noise to be generated.

However, the mainstream of conventional countermeasures against the above-described low-frequency brake noise is solely to increase the rigidity of the carrier (mounting member) or the caliper or to modify the configuration thereof, as stated, for example, in Japanese Patent Application Unexamined Publication (KOKAI) Nos. 2000-97258 and Hei 7-259901. The conventional techniques are not perfectly satisfactory as countermeasures against the low-frequency brake noise.

### SUMMARY OF THE INVENTION

The present inventors took notice of the knuckle side structure to devise a countermeasure against the above-described low-frequency brake noise and found that the torsional rigidity of the two disk brake mounting portions 2 and 3 provided on the knuckle side has a significant effect on the low-frequency brake noise.

That is, the present invention was made on the basis of the above-described technical finding. An object of the present invention is to provide a disk brake mounting apparatus wherein the torsional rigidity of disk brake mounting portions provided on the knuckle side is increased to make a great contribution to the reduction of low-frequency brake noise.

To solve the above-described problem, the present invention provides a disk brake mounting apparatus having a plurality of disk brake mounting portions provided on a knuckle to fasten a disk brake to the knuckle with mounting bolts passed through bolt-receiving holes provided in the mounting portions, respectively. The mounting apparatus is characterized by having a reinforcing connecting portion for directly connecting together the plurality of mounting portions.

In the disk brake mounting apparatus arranged as stated above, the plurality of disk brake mounting portions provided on the knuckle side are directly connected together through the reinforcing connecting portion. Accordingly, the torsional rigidity of the plurality of mounting portions increases. Thus, vibrations in the opposite-phase mode in the rotor axial direction are suppressed.

In the present invention, the reinforcing connecting portion may be an extended portion of the knuckle. The extended portion may be arranged so that the edge of the extended portion lies radially outward in the rotor radial direction with respect to a line connecting the centers of the bolt-receiving holes of at least two of the mounting portions. With this arrangement, the reinforcing connecting portion can be provided simply by modifying the configuration of the knuckle.

In this case, the edge of the extended portion may be provided with a relief for avoiding interference with the cylinder portion of the disk brake.

In this case, the extended portion, at least the edge thereof, may be provided with a rib projecting to the side remote from the disk brake mounting surface side. With this arrangement, the desired strength can be ensured without the need for a large increase in the wall thickness of the reinforcing connecting portion.

In the present invention, the reinforcing connecting portion may be a reinforcing plate prepared separately from the knuckle. The reinforcing plate may be fastened to the knuckle, together with the disk brake, with the mounting bolts for fastening the disk brake to the knuckle. The reinforcement using the reinforcing plate makes it unnecessary to modify the configuration of the knuckle.

### BRIEF DESCRIPTION OF THE DRAWINGS

FIG. 1 is a front view showing the structure of a disk brake mounting apparatus as a first embodiment of the present invention.

FIG. 2 shows sectional views as seen from the directions of the arrows A-A and B-B in FIG. 1.

FIG. 3 is a front view showing the structure of a disk brake mounting apparatus as a second embodiment of the present invention.

FIG. 4 is a front view showing the structure of a disk brake mounting apparatus as a third embodiment of the present invention.

FIG. 5 is a sectional view as seen from the direction of the arrow B-B in FIG. 4.

FIG. 6 is a front view showing the structure of a disk brake mounting apparatus as a fourth embodiment of the present invention.

FIG. 7 is a side view showing the structure of an essential part of the disk brake mounting apparatus shown in FIG. 6.

FIG. 8 is a plan view showing a modified structure of a reinforcing plate used in the fourth embodiment.

FIG. 9 is a side view of the reinforcing plate shown in FIG. 8.

FIG. 10 is a sectional view as seen from the direction of the arrow C-C in FIG. 8.

FIG. 11 is a front view showing the structure of a conventional disk brake mounting apparatus.

FIG. 12 is a sectional view as seen from the direction of the arrow A-A in FIG. 11.

### DETAILED DESCRIPTION OF THE INVENTION

Embodiments of the present invention will be described below in detail with reference to the drawings.

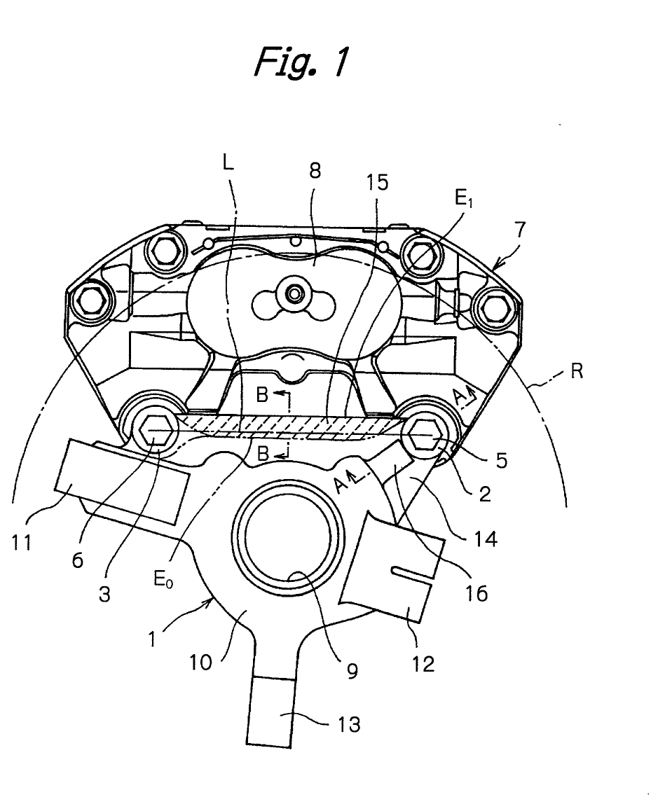

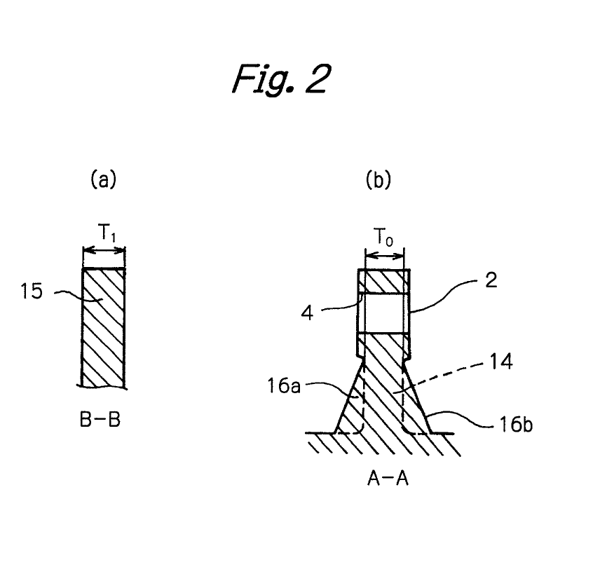

FIGS. 1 and 2 show a first embodiment of the present invention. It should be noted that the general arrangement of the disk brake mounting apparatus is the same as that shown in FIG. 11. Therefore, the same portions as those shown in FIG. 11 are denoted by the same reference symbols. In the first embodiment, the knuckle 1 is provided with a reinforcing connecting portion 15 for directly connecting together the two disk brake mounting portions 2 and 3. In addition, ribs 16a and 16b are provided on both sides of the projecting portion 14 of the mounting portion 2, which extends a relatively long distance. In FIG. 1, the reinforcing connecting portion 15 is shaded (with broken lines) for the convenience of illustration.

The reinforcing connecting portion 15 is an extended portion formed by extending the body portion 10 of the knuckle 1. The edge E1 of the extended portion is located radially outward in the rotor radial direction with respect to a line L connecting the centers of the bolt-receiving holes 4 of the two mounting portions 2 and 3. The thickness T1 of the reinforcing connecting portion 15 is equal to or less than the thickness T0 of the projecting portions (root portions) 14 on which the mounting portions 2 and 3 are provided (T1≦T0). Meanwhile, the ribs 16a and 16b provided on both sides of the projecting portion 14 of the mounting portion 2 are formed so that the height from the surface of the projecting portion 14 increases as it goes toward the body portion 10 of the knuckle 1.

In the first embodiment, the disk brake 7 is of the fixed caliper type, as stated above. Therefore, the caliper 8 containing opposed pistons is fastened to the two mounting portions 2 and 3 of the knuckle 1 by using bolts 5 and 6. In this mounted state, the opposed pistons in the caliper 8 advance toward each other, causing a pair of brake pads (not shown), which are provided on the inner and outer sides of the vehicle, to be pressed against the rotor R, and thus generating braking force.

At this time, the opposite ends of the caliper 8 are forced to oscillate in opposite directions in the rotor axial direction. However, the two disk brake mounting portions 2 and 3 of the knuckle 1 are directly connected together through the reinforcing connecting portion 15 to increase the rigidity, particularly torsional rigidity, of the mounting portions 2 and 3. Therefore, it is possible to suppress the above-described oscillation of the caliper 8, that is, vibrations in the opposite-phase mode in the rotor axial direction. As a result, low-frequency brake noise is reduced. In the first embodiment, in particular, the ribs 16a and 16b are provided on both sides of the root portion (projecting portion) 14 of the mounting portion 2, which extends a relatively long distance. Therefore, the rigidity of the mounting portion 2 is increased to an even higher degree. Consequently, low-frequency brake noise reduces markedly. Further, in the first embodiment, the thickness T1 of the reinforcing connecting portion 15 is set equal to or less than the thickness T0 of the projecting portions 14 on which the mounting portions 2 and 3 are provided. Therefore, the increase in weight due to the extension of the body portion 10 of the knuckle 1 is not very large.

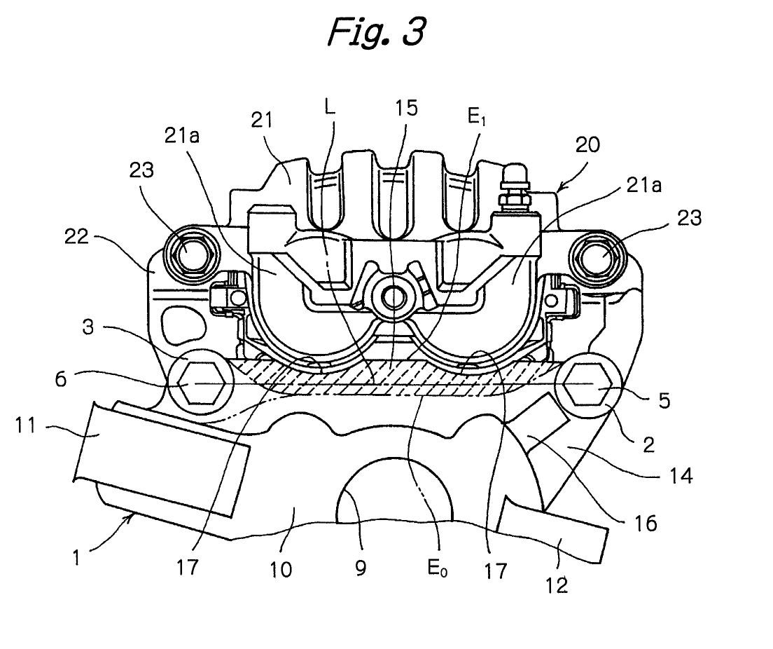

FIG. 3 shows a second embodiment of the present invention. A disk brake 20 to which the present invention is applied in the second embodiment is of the floating caliper type. A caliper 21 containing two pistons is floatably supported by a carrier 22 with a pair of pins (left and right pins) 23. The carrier 22 is fastened to two mounting portions 2 and 3 of a knuckle 1 by using bolts 5 and 6 in the same way as in the first embodiment. In the second embodiment, the caliper 21 has cylinder portions 21a containing two pistons, respectively. The cylinder portions 21a bulge downward in the shape of a pair of glasses. Therefore, if the edge E1 of the reinforcing connecting portion 15 is in a straight-line shape as in the first embodiment, the cylinder portions 21a would interfere with the edge E1. Therefore, in the second embodiment, the edge E1 of the reinforcing connecting portion 15 is provided with concave relieves 17 for avoiding interference with the cylinder portions 21a. It should be noted that the knuckle side structure is substantially the same as that in the first embodiment except for a slight change in the overall size. Therefore, the same portions as those in the first embodiment are denoted by the same reference symbols.

The disk brake 20 is of the floating caliper type, as has been stated above. Therefore, when the pistons in the cylinder portions 21a of the caliper 21 advance, the inner brake pad, which is provided on the inner side of the vehicle, is pressed against the disk D. Counterforce produced at this time causes the caliper 21 to retract. Consequently, a claw portion (not shown) at the distal end of the caliper 21 causes the outer brake pad, which is provided on the outer side of the vehicle, to be pressed against the rotor R. Thus, braking force is generated. At this time, the opposite ends of the carrier 22 are forced to oscillate in opposite directions in the rotor axial direction. However, the two disk brake mounting portions 2 and 3 of the knuckle 1 are directly connected together through the reinforcing connecting portion 15 to increase the torsional rigidity of the mounting portions 2 and 3. Therefore, it is possible to suppress the oscillation of the carrier 22, that is, vibrations in the opposite-phase mode in the rotor axial direction. Accordingly, low-frequency brake noise is reduced in the same way as in the first embodiment.

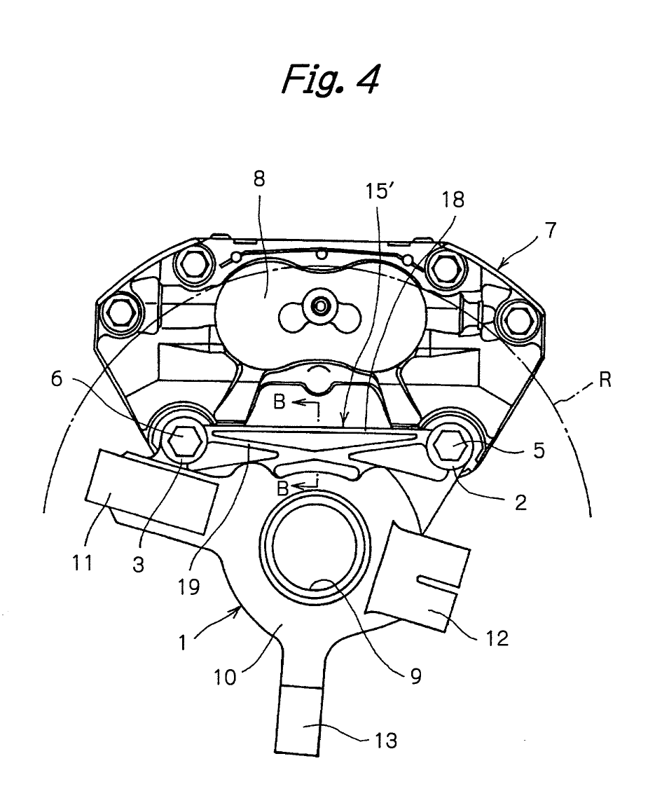

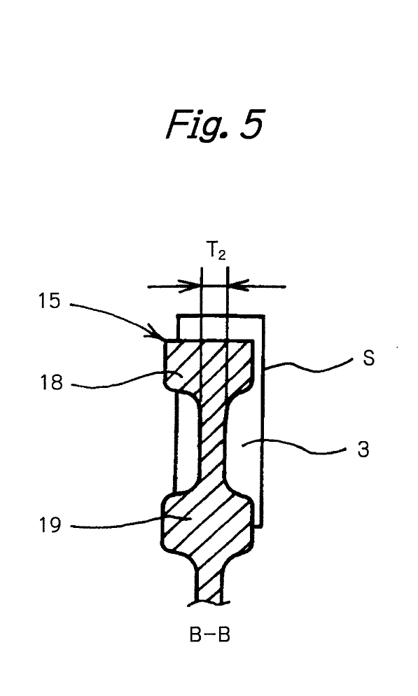

FIGS. 4 and 5 show a third embodiment of the present invention. The feature of the third embodiment resides in that the configuration of the reinforcing connecting portion 15 provided in the first embodiment is modified, and the ribs 16a and 16b provided on the root portion 14 of one mounting portion 2 are omitted. That is, the reinforcing connecting portion 15′ has a first rib 18 provided on the edge portion thereof and an X-shaped second rib 19 provided inside the edge portion. The first and second ribs 18 and 19 are provided offset toward the side remote from the disk brake mounting surface S of the mounting portions 2 and 3 so as not to project from the mounting surface S. The thickness T2 of the base area of the reinforcing connecting portion 15′, exclusive of the first and second ribs 18 and 19, is set not more than the half of the thickness T0 (FIG. 2) of the root portions 14 of the mounting portions 2 and 3 (T2≦½T0).

In the third embodiment, the rigidity of the reinforcing connecting portion 15′ is sufficiently ensured by the first and second ribs 18 and 19. Therefore, the reinforcing connecting portion 15′ allows the torsional rigidity of the two mounting portions 2 and 3 to be increased in the same way as in the first embodiment and hence suppresses vibrations of the caliper 8 in the opposite-phase mode in the rotor axial direction. Thus, low-frequency brake noise is reduced. Further, the base area of the reinforcing connecting portion 15′ is sufficiently thin in thickness. Therefore, the reinforcing connecting portion 15′ is lighter in weight than the reinforcing connecting portion 15 in the first embodiment. This contributes to the reduction in weight of the unsprung mass of the vehicle.

It should be noted that the first and second ribs 18 and 19 may be formed to project to only the side remote from the disk brake mounting surface S. Further, the second rib 19 may be omitted. That is, the reinforcing connecting portion 15′ may have a structure in which only the first rib 18 is provided.

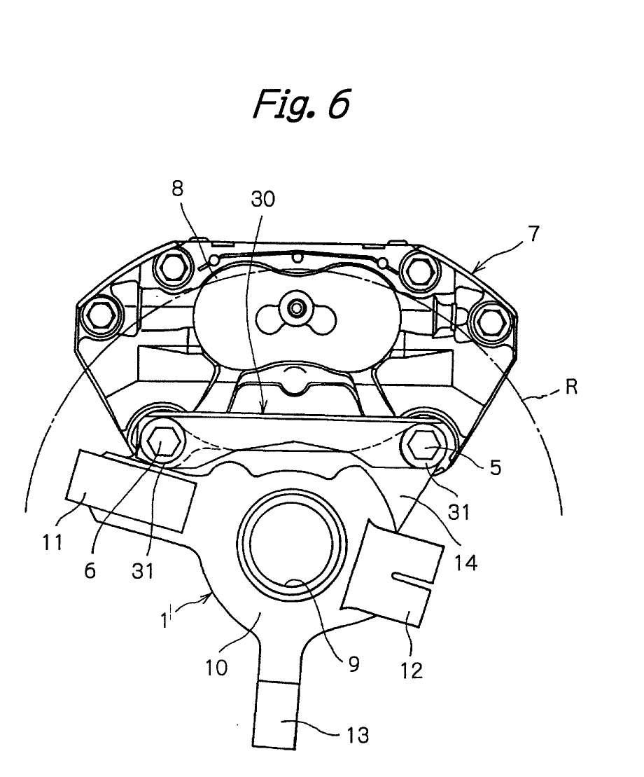

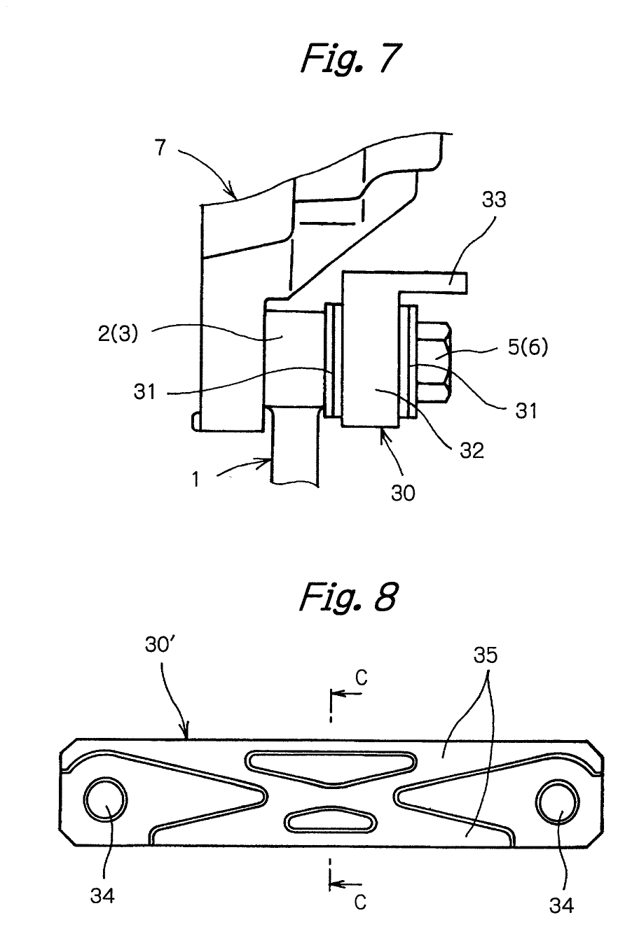

FIGS. 6 and 7 show a fourth embodiment of the present invention. In the fourth embodiment, a reinforcing plate 30 is prepared separately from the knuckle 1 in place of the reinforcing connecting portion 15 or 15′, which is formed by extending the body portion 10 of the knuckle 1 in the first to third embodiments. The reinforcing plate 30 is disposed to bridge the gap between the two mounting portions 2 and 3 of the knuckle 1, and both end portions of the reinforcing plate 30 are fastened, together with the disk brake 7, by using the mounting bolts 5 and 6 and washers 31. In this embodiment, the reinforcing plate 30 has a flat plate-shaped body portion 32. The body portion 32 has a rib 33 projecting from the upper edge of the body portion 32 to the side remote from the disk brake mounting surface S. It should be noted that there is no change in the knuckle 1 and the disk brake 7; these are the same as those used in the conventional apparatus. Therefore, in FIG. 6, the same portions as those shown in FIG. 11 are denoted by the same reference symbols.

In the fourth embodiment, because the disk brake mounting portions 2 and 3 provided on the knuckle 1 are reinforced by the reinforcing plate 30, the torsional rigidity of the mounting portions 2 and 3 is increased. Thus, vibrations of the caliper 8 in the opposite-phase mode in the rotor axial direction are suppressed, and low-frequency brake noise is reduced. In the fourth embodiment, in particular, the knuckle 1 needs no change in the configuration. Therefore, there is no increase in the production cost thereof.

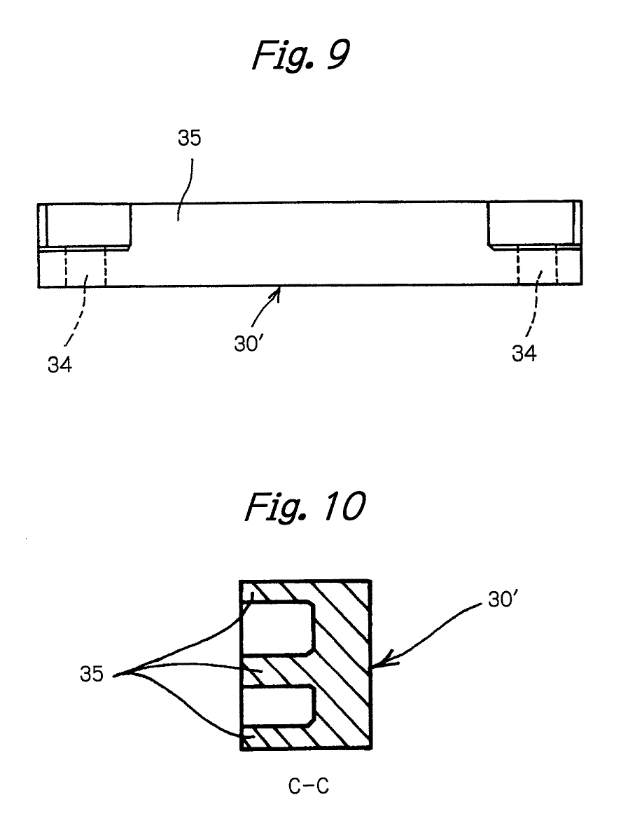

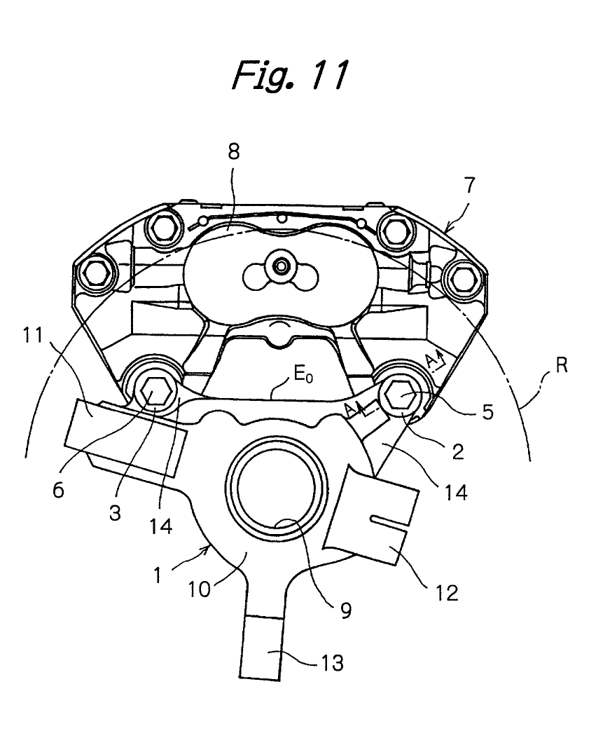

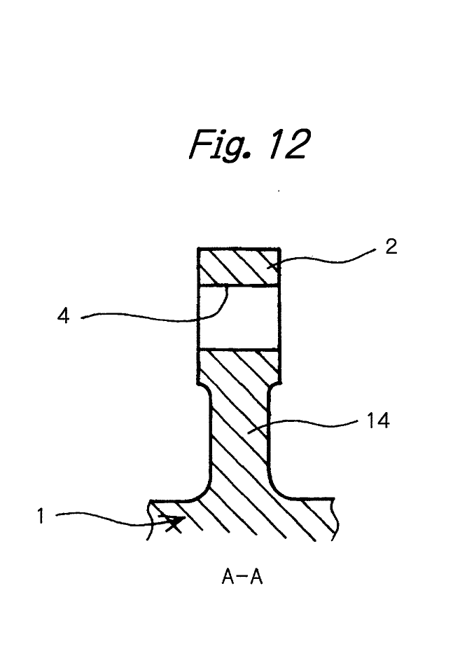

It should be noted that the reinforcing plate 30 can have any desired configuration. It is possible to use a reinforcing plate 30′ as shown in FIGS. 8 to 10 by way of example, which has odd-shaped ribs 35 on portions thereof other than bolt-receiving holes 34 at both ends of the reinforcing plate 30′.

As has been detailed above, the disk brake mounting apparatus according to the present invention is arranged to increase the torsional rigidity of a plurality of disk brake mounting portions provided on the knuckle. Therefore, vibrations in the opposite-phase mode in the rotor axial direction are suppressed, and low-frequency brake noise is reduced to a considerable extent.

What is claimed is:

1. A disk brake mounting apparatus having a knuckle provided with a plurality of projecting portions projecting in rotor radial directions, said plurality of projecting portions being provided with disk brake mounting portions, respectively, whereby a disk brake is fastened to the knuckle with mounting bolts passed through bolt-receiving holes provided in the mounting portions, respectively,
wherein a reinforcing connecting portion is provided for directly connecting together said plurality of mounting portions.

2. A disk brake mounting apparatus according to claim 1, wherein said reinforcing connecting portion is an extended portion of said knuckle, said extended portion being arranged so that an edge thereof lies radially outward in the rotor radial direction with respect to a line connecting centers of said bolt-receiving holes of at least two of said mounting portions.

3. A disk brake mounting apparatus according to claim 2, wherein said extended portion, at least the edge thereof, is provided with a rib projecting to a side remote from a disk brake mounting surface side.

4. A disk brake mounting apparatus according to claim 1, wherein said reinforcing connecting portion is a reinforcing plate prepared separately from said knuckle, said reinforcing plate being fastened to said knuckle, together with the disk brake, with said mounting bolts for fastening said disk brake to said knuckle.

5. A disk brake mounting apparatus according to claim 4, wherein said reinforcing plate, at least an edge thereof, is provided with a rib projecting to a side remote from a disk brake mounting surface side.

6. A disk brake mounting apparatus according to claim 1, wherein at least one of said plurality of projecting portions is provided with a rib extending in the rotor radial direction.

7. A disk brake mounting apparatus according to claim 2, wherein at least one of said plurality of projecting portions is provided with a rib extending in the rotor radial direction.

8. A disk brake mounting apparatus according to claim 3, wherein at least one of said plurality of projecting portions is provided with a rib extending in the rotor radial direction.

9. A disk brake mounting apparatus according to claim 1, wherein a thickness (T₁) of said reinforcing connecting portion in an axial direction of the bolt-receiving hole is equal to or less than a thickness (T₀) of said projecting portion in the axial direction of the bolt-receiving hole (T₁≦T₀).

10. A disk brake mounting apparatus according to claim 2, wherein a thickness (T₁) of said reinforcing connecting portion in an axial direction of the bolt-receiving hole is equal to or less than a thickness (T₀) of said projecting portion in the axial direction of the bolt-receiving hole (T₁≦T₀).

11. A disk brake mounting apparatus according to claim 3, wherein a thickness (T₁) of said reinforcing connecting portion in an axial direction of the bolt-receiving hole is equal to or less than a thickness (T₀) of said projecting portion in the axial direction of the bolt-receiving hole (T₁≦T₀).

12. A disk brake mounting apparatus according to claim 1, wherein an edge of said reinforcing connecting portion is provided with a relief for avoiding interference when the disk brake is secured to said knuckle.

13. A disk brake mounting apparatus according to claim 2, wherein the edge of said reinforcing connecting portion is provided with a relief for avoiding interference when the disk brake is secured to said knuckle.

14. A disk brake mounting apparatus according to claim 3, wherein the edge of said reinforcing connecting portion is provided with a relief for avoiding interference when the disk brake is secured to said knuckle.

15. A disk brake mounting apparatus according to claim 4, wherein an edge of said reinforcing connecting portion is provided with a relief for avoiding interference when the disk brake is secured to said knuckle.
